(19) United States
(12) Patent Application Publication
(10) Pub. No.: US 2021/0392859 A1
(43) Pub. Date: Dec. 23, 2021

(54) Beeswax Foundation System

(71) Applicant: Andrew C Bonde, Randolph, WI (US)

(72) Inventor: Andrew C Bonde, Randolph, WI (US)

(21) Appl. No.: 17/349,233

(22) Filed: Jun. 16, 2021

Related U.S. Application Data
(60) Provisional application No. 63/040,181, filed on Jun. 17, 2020.

(51) Int. Cl. A01K 47/06

(52) U.S. Cl. CPC A01K 47/06

(57) ABSTRACT

A beeswax foundation system for use in a beehive. The beeswax foundation system allows for easy access to and removal of the honeycomb from the hive without damaging the honeycomb. A first and second plastic frame members are mated together retaining a removable beeswax foundation within. A snap lock component holds the first and second plastic frame members in place. The snap lock component is unlocked to separate the first and second plastic frame members to access the removable beeswax foundation. The unlocked first and second plastic frame members are then reusable with a new removable beeswax foundation once cleaned.

### CROSS-REFERENCE TO RELATED APPLICATION

The present application claims priority to, and the benefit of, U.S. Provisional Application No. 63/040,181, which was filed on Jun. 17, 2020 and is incorporated herein by reference in its entirety.

### BACKGROUND

The present invention generally relates to a system for removing a honeycomb from a beehive, and more specifically to an easily accessible and cleanable beeswax foundation system. Accordingly, the present specification makes specific reference thereto. However, it is to be appreciated that aspects of the present invention are also equally amenable to other like applications, devices, and methods of manufacture.

By way of background, a beehive is an enclosed man-made structure in which some honeybee species of the subgenus Apis live and raise their young. A beehive is an artificial structure for housing a honeybee nest as opposed to a nest of any bee colony that is found in natural or artificial cavities. Commercial honey producers keep bee colonies in man-made beehives for ease of operations and convenience.

The internal structure of a nest in a beehive is a densely packed group of hexagonal prismatic cells made of beeswax, called a honeycomb. The cells are used to store honey and pollen and to house the eggs, larvae, and pupae of the bees. Beehives are used for commercial production of honey, pollination of crops, and to mitigate the effects of colony collapse disorder. Hives are easily transported so that bees can pollinate crops in other areas.

Traditional beehives have no internal structure and simply provided an enclosure for the bee colony. Bees then create their own honeycomb within the enclosure. The bee created comb is often cross-attached to the structure and cannot be moved without destroying the comb. A hive frame or honey frame is a structural element that can be placed inside the beehive to hold the honeycomb. The hive frame is easily removable from the hive in order to inspect the bees for disease or to easily extract excess honey.

A wax foundation or honeycomb base is a plate made of wax used to form the base of a honeycomb. A wax foundation is used to give the bees a foundation on which they can build their honeycomb. A wax or plastic foundation is inserted into a wooden or plastic frame through the top and may also be connected to the side bars with wire. The foundation also alleviates the risk of having comb built outside the hive preventing easy removal. Standard wooden frames used for beeswax foundations typically require a wood strip or groove in the top bar for securement. The bees then fill the frame with honey, and the comb is cut out of the frame and harvested. The frame must be scraped and cleaned of all waxy residue to be installed in another foundation.

Accordingly, there is a great need for a way for beekeepers to save time when harvesting honey. There is also a need for a way for foundation for facilitating removal of a honeycomb from a beehive. Similarly, there is a need for a beeswax frame that allows easy access to the honeycomb. There is also a need for a replacement for standard wood frames that require a strip or groove to secure the beeswax foundation.

In this manner, the improved beeswax foundation system of the present invention accomplishes all of the forgoing objectives, thereby providing an easy solution for making it simpler to harvest honey from a beehive. A primary feature of the present invention is an improved frame for retaining a beeswax foundation. The present invention allows for easy access to and removal of the honeycomb from the hive. Finally, the improved beeswax foundation system of the present invention is capable of eliminating the need for a strip or groove to secure the beeswax foundation.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a beeswax foundation system. The beeswax foundation system is configured to retain a beeswax foundation and removably position it within a beehive. The beeswax foundation system is separable into its component parts for easy removal of a honeycomb and for cleaning.

The beeswax foundation system comprises a frame assembly. The frame assembly comprises a first frame member and a second frame member. The second frame member is mateable or connectable with the first frame member, typically by snap-fitting or snap-locking. The first and second frame members are injection molded plastic frames. The first and second frame members are configured to retain the beeswax foundation between them when mated together.

The first frame member comprises a first side rail and a second side rail. The first and second side rails are connected by a top rail and a base rail. The top rail comprises a pair of extension elements extending laterally sideways. The pair of extension elements are configured to hold the frame assembly in a hanging space in the beehive. The first frame member further comprises a beeswax foundation retaining channel. The beeswax foundation retaining channel is molded or grooved into an inside facing side of the first frame member.

The first side rail comprises a plurality of cantilever beam retaining slots. Each cantilever beam retaining slot is a channel molded into an outward facing side of the first side rail. Each cantilever beam retaining slot comprises a catch located within the slot. The second side rail comprises a plurality of cantilever beams. Each cantilever beam is molded into and extends perpendicularly out of the second side rail. Each cantilever beam comprises a catch receiving opening.

The second first frame member similarly comprises a first side rail and a second side rail. The first and second side rails are connected by a top rail and a base rail. The top rail comprises a pair of extension elements extending laterally sideways. The pair of extension elements are configured to hold the frame assembly in a hanging space in the beehive in conjunction with the pair of extension elements of the top rail of the first frame member. The second frame member further comprises a beeswax foundation retaining channel. The beeswax foundation retaining channel is molded or grooved into an inside facing side of the second frame member and mirrors the beeswax foundation retaining channel of the first frame member.

The first side rail comprises a plurality of cantilever beams. Each cantilever beam is molded into and extends perpendicularly out of the first side rail. Each cantilever beam comprises a catch receiving opening. The second side rail comprises plurality of cantilever beam retaining slots. Each cantilever beam retaining slot is a channel molded into an outward facing side of the second side rail. Each cantilever beam retaining slot comprises a catch located within the slot.

The first side rail of the first frame member is configured to mate with the second side rail of the second frame member. Each cantilever beam retaining slot is configured to engage and retain one of the cantilever beams. Each catch of each cantilever beam retaining slot is configured to engage the respective catch receiving opening of the respective cantilever beam.

In another embodiment, the first side rail of the first frame member may comprise a cantilever beam and a cantilever beam retaining slot. The second side rail of the first frame member may also comprise a cantilever beam and a cantilever beam retaining slot. Similarly, the first side rail of the second frame member may comprise a cantilever beam and a cantilever beam retaining slot. The second side rail of the second frame member may also comprise a cantilever beam and a cantilever beam retaining slot. Each of the cantilever beams may be adjacent to the top rail or the base rail. Alternatively, the cantilever beam of each first side rail is adjacent to the top rail, and the cantilever beam of each second side rail is adjacent to the base rail in an alternating fashion.

In another embodiment, the first frame member comprises a plurality of cantilever beam retaining slots and no cantilever beams. The second frame member comprises a plurality of cantilever beams and no cantilever beams retaining slots. As such, the first frame member functions as a female connection for the male connectors of the second frame member.

The beeswax foundation system may further comprises a beeswax foundation. The beeswax foundation is wax plate for use by bees in generating a honeycomb. The beeswax foundation is positional between the first and second frame members and is retained within each of the beeswax foundation retaining channels when the first and second frame members are mated together.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a beeswax foundation system of the present invention in a disassembled configuration for use in a beehive in accordance with the disclosed architecture.

FIG. 2 illustrates a perspective view of the beeswax foundation system of the present invention in an assembled configuration for use in a beehive in accordance with the disclosed architecture.

FIG. 3 illustrates a perspective view of a first and second frame members of the frame assembly of the beeswax foundation system of the present invention for use in a beehive in accordance with the disclosed architecture.

FIG. 4 illustrates a perspective view of a frame assembly of the beeswax foundation system of the present invention for use in a beehive in accordance with the disclosed architecture.

FIG. 5 illustrates a perspective view of a frame assembly of the beeswax foundation system of the present invention for use in a beehive in accordance with the disclosed architecture.

FIG. 6 illustrates a close up view of a snap-fit type connection to connect the frame assembly of the beeswax foundation system of the present invention for use in a beehive in accordance with the disclosed architecture.

FIG. 7 illustrates a close up view of an alternative snap-fit type connection to connect the frame assembly of the beeswax foundation system of the present invention for use in a beehive in accordance with the disclosed architecture.

FIG. 8 illustrates a perspective view of the beeswax foundation system of the present invention in an assembled configuration in use in a beehive in accordance with the disclosed architecture

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The invention provides beekeepers with a modified, snap-together frame for beeswax foundation systems, and features a snap lock on the sides of the frame for connecting the components together with ease. The invention firmly affixes the beeswax foundation between the two locking halves of the frame, saving extensive time and effort during the installation and replacement process, and replaces standard wood frames that typically require a strip or groove in the top bar to secure the foundation.

The present invention, in one exemplary embodiment, is a plastic frame designed to save time and effort for beekeepers. The device is comprised of an injection molded plastic frame with a snap locking feature. A two piece snap-lock function firmly affixes the beeswax foundation between the two halves of the frame. Users can insert and remove the foundation with ease, simply unlocking or locking together the frame for installation. A honeycomb can be removed from the frame, and the frame can be washed in warm water for reapplication of the foundation. The invention may be of any dimension needed, such as to fit a standard Langstroth wooden bee frame used for honeycomb production.

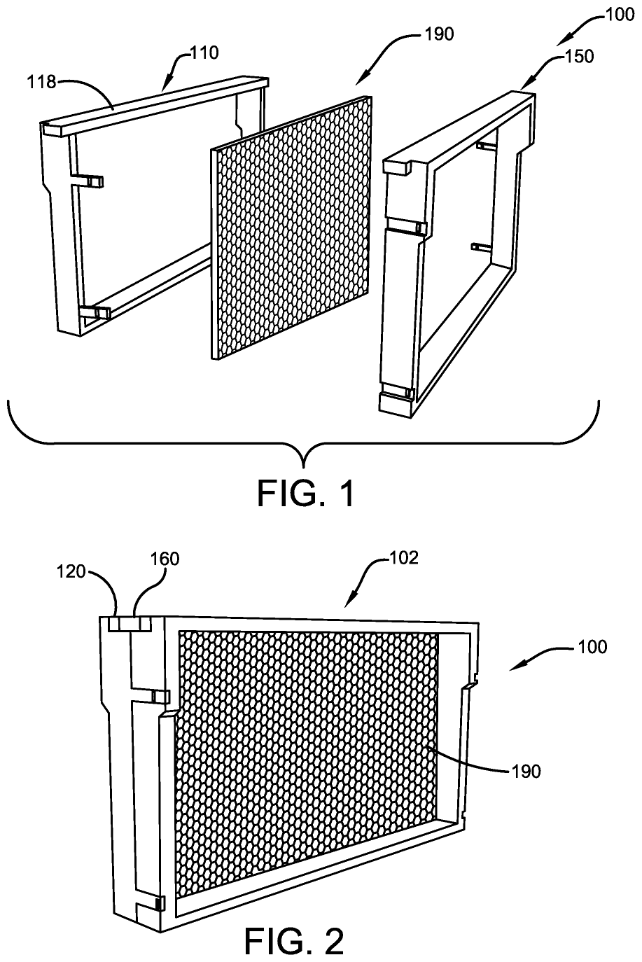

Referring initially to the drawings, FIGS. 1-8 illustrates a beeswax foundation system 100. The beeswax foundation system 100 is constructed to allow for easy access to and removal of a honeycomb from a beehive 10 without damaging the honeycomb as illustrated in FIG. 8. The beeswax foundation system 100 is configured to retain a beeswax foundation 190 and removably position it within the beehive 10. The beeswax foundation system 100 is separable into its component parts for easy removal of the honeycomb and for cleaning.

As illustrated in FIG. 1, the beeswax foundation system 100 comprises a frame assembly 102. The frame assembly 102 comprises a first frame member 110 and a second frame member 150. The second frame member 150 is mateable or connectable with the first frame member 110 and vice versa, typically by snap-fitting or snap-locking. The first and second frame members 110 and 150 are injection molded plastic frames. As illustrated in FIG. 2, the first and second frame members 110 and 150 are configured to retain the beeswax foundation 190 between them when mated together.

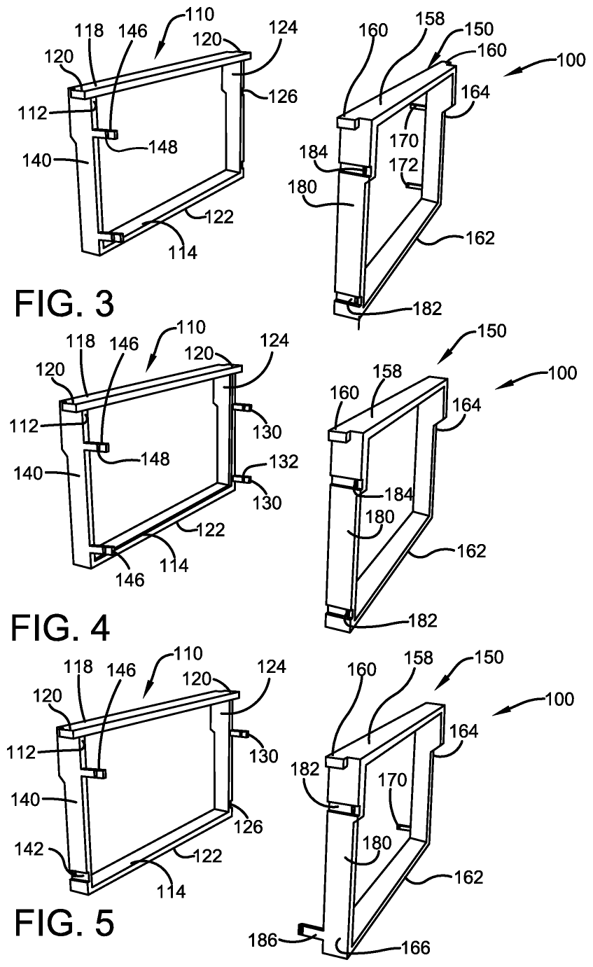

As illustrated in FIG. 3, the first frame member 110 comprises a first side rail 124 and a second side rail 140. The first and second side rails 124 and 140 are connected by a top rail 118 and a base rail 122. The top rail 118 comprises a pair of extension elements 120 extending laterally sideways out of the top rail 118. The pair of extension elements 120 are configured to hold the frame assembly 102 in a hanging space in the beehive 10. The first frame member 124 further comprises a beeswax foundation retaining channel 114. The beeswax foundation retaining channel 114 is molded or grooved into an inside facing side 112 of the first frame member 110. The beeswax foundation retaining channel 114 extends around the base rail 122 and the side rails 124 and 140.

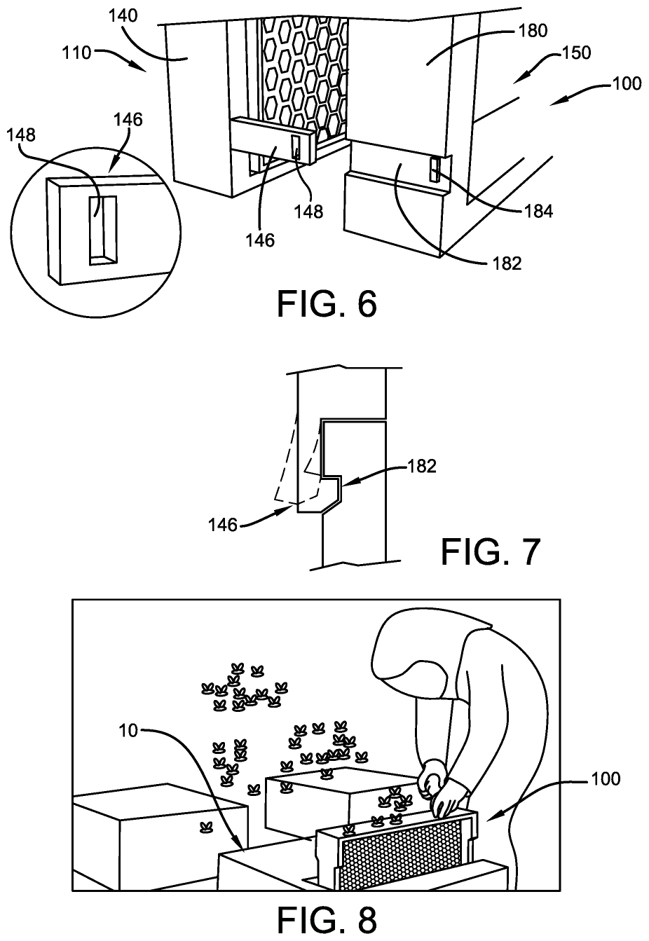

The first side rail 124 comprises a plurality of cantilever beam retaining slots 126. Each cantilever beam retaining slot 126 is a channel molded into an outward facing side of the first side rail 124. As illustrated in FIG. 6, each cantilever beam retaining slot 126 comprises a catch (similar to 148) located within the slot. The catch 126 may be a tang or similar protuberance. The second side rail 140 comprises a plurality of cantilever beams 146. Each cantilever beam 146 is molded into and extends perpendicularly out of the second side rail 140. Each cantilever beam 146 comprises a catch receiving opening 148 or hole. Each cantilever beam 146 is flexible and will bend outward before returning to its perpendicular orientation.

The second first frame member 150 similarly comprises a first side rail 164 and a second side rail 180. The first and second side rails 164 and 180 are connected by a top rail 158 and a base rail 162. The top rail 158 comprises a pair of extension elements 160 extending laterally sideways out of the top rail. The pair of extension elements 160 are configured to hold the frame assembly 102 in the hanging space in the beehive 10 in conjunction with the pair of extension elements 120 of the top rail 118 of the first frame member 110. The second frame member 150 further comprises a beeswax foundation retaining channel (similar to 114). The beeswax foundation retaining channel is molded or grooved into an inside facing side of the second frame member 150 and mirrors the beeswax foundation retaining channel 114 of the first frame member 110. The beeswax foundation retaining channel extends around the base rail 162 and the side rails 164 and 180.

The first side rail 164 comprises a plurality of cantilever beams 170 similar in construction and function to the plurality of cantilever beams 146 of the second frame member 110. Each cantilever beam 170 is molded into and extends perpendicularly out of the first side rail 164. Each cantilever beam 170 comprises a catch receiving opening 172. Each cantilever beam 146 is flexible and will bend outward before returning to its perpendicular orientation. The second side rail 180 comprises plurality of cantilever beam retaining slots 182. Each cantilever beam retaining slot 182 is a channel molded into an outward facing side of the second side rail 180. Each cantilever beam retaining slot 182 comprises a catch 184 located within the slot. The catch 184 may be a tang or similar protuberance.

The first side rail 124 of the first frame member 110 may be configured to mate with the second side rail 180 of the second frame member 150. Alternatively, the first side rail 124 of the first frame member 110 may be configured to mate with the first side rail 164 of the second frame member 150 depending on how the beams and slots are located. Generally, each cantilever beam retaining slot is configured to engage and retain one of the cantilever beams. Each catch of each cantilever beam retaining slot is configured to engage the respective catch receiving opening of the respective cantilever beam in a snap-fit or snap-lock type connection. Alternatively, as illustrated in FIG. 6, each cantilever beam may comprise a tang for engaging the respective cantilever beam retaining slot.

In one example, the plurality of cantilever beam retaining slots 126 of the first side rail 124 of the first frame member 110 are located to mate with the plurality of cantilever beams 170 of the first side rail 164 of the second frame member 150. The plurality of cantilever beams 146 of the second side rail 140 of the first frame member 110 are located to mate with the plurality of cantilever beam retaining slots 182 of the second side rail 180 of the second frame member 150. The catch of each slot releasably engages and temporarily retains the catch receiving opening of the respective beam.

In another embodiment as illustrated in FIG. 4, the first side rail 124 of the first frame member 110 may comprise a cantilever beam 130 comprising a catch receiving opening 132 and a cantilever beam retaining slot 126 comprising a catch (similar to 148). The second side rail 140 of the first frame member 110 may also comprise a cantilever beam 146 comprising a catch receiving opening 148 and a cantilever beam retaining slot 142 comprising a catch 144. Similarly, the first side rail 164 of the second frame member 150 may comprise a cantilever beam 170 comprising a catch receiving opening 172 and a cantilever beam retaining slot (similar to 182) comprising a catch (similar to 184). The second side rail 180 of the second frame member 150 may also comprise a cantilever beam 186 comprising a catch receiving opening 188 and a cantilever beam retaining slot 182 comprising a catch 184.

Each of the cantilever beams may be adjacent to the respective top rail. Alternatively, each of the cantilever beams may be adjacent to the respective base rail. Alternatively, the cantilever beam of each first side rail is adjacent to the respective top rail, and the cantilever beam of each second side rail is adjacent to the respective base rail in an alternating fashion.

In another embodiment as illustrated in FIG. 5, the first frame member 110 comprises a plurality of cantilever beam retaining slots 126 and no cantilever beams. The second frame member 150 comprises a plurality of cantilever beams 146 and no cantilever beams retaining slots. As such, the first frame member 110 functions as a female connection for the male connectors of the second frame member 150.

The beeswax foundation system 100 may further comprises a beeswax foundation 190. The beeswax foundation 190 is wax plate for use by bees in generating a honeycomb. The beeswax foundation 190 is positional between the first and second frame members 110 and 150 and is retained within each of the beeswax foundation retaining channels 114 when the first and second frame members 110 and 150 are mated together.

Notwithstanding the forgoing, the beeswax foundation system 100 can be any suitable size, shape, and configuration as is known in the art without affecting the overall concept of the invention, provided that it accomplishes the above stated objectives. One of ordinary skill in the art will appreciate that the shape and size of the beeswax foundation system 100 and its various components, as show in the FIGS. are for illustrative purposes only, and that many other shapes and sizes of the beeswax foundation system 100 are well within the scope of the present disclosure. Although dimensions of the beeswax foundation system 100 and its components (i.e., length, width, and height) are important design parameters for good performance, the beeswax foundation system 100 and its various components may be any shape or size that ensures optimal performance during use and/or that suits user need and/or preference. As such, the beeswax foundation system 100 may be comprised of sizing/shaping that is appropriate and specific in regard to whatever the beeswax foundation system 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A beeswax foundation system for retaining a beeswax foundation comprising:
a frame assembly comprising:
a first frame member comprising a first side rail comprising a plurality of cantilever beam retaining slots, and a second side rail comprising a plurality of cantilever beams;
a second frame member mateable with the first frame member, the second frame member comprising a first side rail comprising a plurality of cantilever beams, and a second side rail comprising a plurality of cantilever beam retaining slots; and
wherein the first and second frame members are configured to retain the beeswax foundation between them when mated together.

2. The beeswax foundation system of claim 1, wherein the first and second frame members are injection molded plastic frames.

3. The beeswax foundation system of claim 1, wherein the first and second frame members snap-fit together.

4. The beeswax foundation system of claim 1, wherein each cantilever beam retaining slot is a channel molded into an outward facing side of the respective side rail.

5. The beeswax foundation system of claim 1, wherein each cantilever beam retaining slot is configured to engage and retain one of the cantilever beams.

6. The beeswax foundation system of claim 1, wherein each cantilever beam retaining slot comprises a catch for engaging the respective cantilever beam.

7. The beeswax foundation system of claim 1, wherein each cantilever beam is molded into and extends perpendicularly out of the respective side rail.

8. The beeswax foundation system of claim 1, wherein each cantilever beam comprises a catch receiving opening for engaging the respective cantilever beam retaining slot.

9. The beeswax foundation system of claim 1, wherein each cantilever beam is flexible.

10. The beeswax foundation system of claim 1, wherein each frame member further comprises a beeswax foundation retaining channel molded into an inward facing side of the frame member.

11. The beeswax foundation system of claim 1, wherein each frame member further comprises a pair of extension elements extending from a top rail of each frame member for holding the frame assembly in a hanging space within a beehive.

12. The beeswax foundation system of claim 1, wherein the plurality of cantilever beam retaining slots of the first side rail of the first frame member are located to mate with the plurality of cantilever beams of the first side rail of the second frame member, and the plurality of cantilever beams of the second side rail of the first frame member are located to mate with the plurality of cantilever beam retaining slots of the second side rail of the second frame member.

13. The beeswax foundation system of claim 1, wherein each cantilever beam comprises a tang for engaging the respective cantilever beam retaining slot.

14. A beeswax foundation system for retaining a beeswax foundation comprising:
a frame assembly comprising:
a first frame member comprising a first side rail comprising a cantilever beam and a cantilever beam retaining slot, and a second side rail comprising a cantilever beam and a cantilever beam retaining slot,
a second frame member mateable with the first frame member, the second frame member comprising a first side rail comprising a cantilever beam and a cantilever beam retaining slot, and a second side rail comprising a cantilever beam and a cantilever beam retaining slot; and
wherein the first and second frame members are configured to retain the beeswax foundation between them when mated together.

15. The beeswax foundation system of claim 14, wherein each frame member further comprises a top rail and a base rail connecting the first and second side rails.

16. The beeswax foundation system of claim 15, wherein each cantilever beam is adjacent to the top rail.

17. The beeswax foundation system of claim 15, wherein each cantilever beam is adjacent to the base rail.

18. The beeswax foundation system of claim 15, wherein the cantilever beam of each first side rail is adjacent to the top rail, and the cantilever beam of each second side rail is adjacent to the base rail.

19. The beeswax foundation system of claim 14, wherein each frame member further comprises a beeswax foundation retaining channel molded into an inward facing side of the frame member.

20. A beeswax foundation system comprising:
a frame assembly comprising:
a first frame member comprising a pair of side rails each comprising a plurality of cantilever beam retaining slots;
a second frame member mateable with the first frame member, the second frame member comprising a pair of side rails each comprising a plurality of cantilever beams; and
beeswax foundation positional between the first and second frame members when mated together.
